(19) United States
(12) Patent Application Publication
(10) Pub. No.: US 2010/0047035 A1
(43) Pub. Date: Feb. 25, 2010

(54) Fastening element

(75) Inventors: Falk Rosenkranz, Wildhaus (CH); Holger Basche, Meiningen (AT); Franz Huber, Markt Wald (DE); Peter Gstach, Schaan (LI)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/583,555

(22) Filed: Aug. 21, 2009

(30) Foreign Application Priority Data
Aug. 22, 2008 (DE) DE10 2008 041 467

(51) Int. Cl. F16B 25/10

(52) U.S. Cl. 411/387.4

(57) ABSTRACT

A fastening element having a torque-receiver for a setting tool and having a shank bearing a tapping thread that has a free end facing away from the torque-receiving means, and that has a thread-core diameter. The thread has one thread having a thread leading end in the region of the free end of the shank, whose outside diameter, starting from the free end, increases to a maximum outside diameter and, starting from its maximum outside diameter and continuing toward the torque-receiving means, decreases quasi-continuously to a smaller outside diameter. The thread-core diameter of the shank, starting from a region next to the torque-receiving means and continuing toward the free end of the shank, decreases quasi-continuously to a smaller thread-core diameter of the shank.

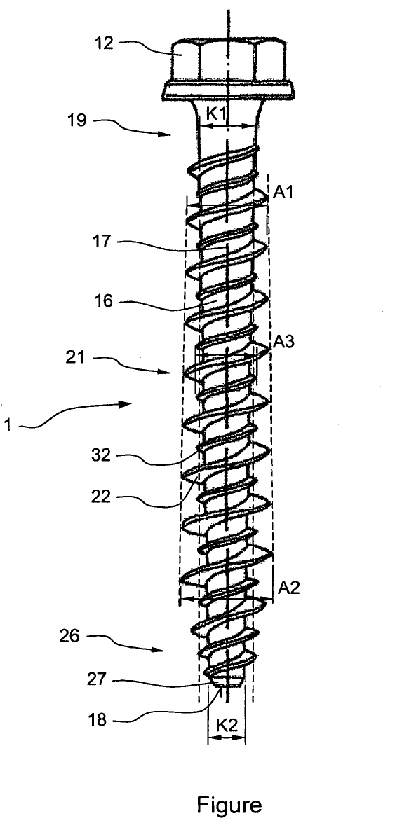

This claims priority to German Patent Application DE 10 2008 041 467.0, filed Aug. 22, 2008, the entire disclosure of which is hereby incorporated by reference herein.

The present invention relates to a fastening element having a torque-receiving means for a setting tool and having a shank bearing a tapping thread that has a free end facing away from the torque-receiving means, and that has a thread-core diameter. The thread has at least one thread having a thread leading end in the region of the free end of the shank, whose outside diameter, starting from the free end, increases to a maximum outside diameter and, starting from its maximum outside diameter and continuing toward the torque-receiving means, decreases quasi-continuously to a smaller outside diameter.

### BACKGROUND OF THE INVENTION

A fastening element of this kind, such as a concrete screw or an internally threaded sleeve having an external thread, is screwed into a drilled hole prepared in advance in a component or workpiece, using a setting tool, such as a tangential impact screwdriver, for example; to anchor the fastening element, its tapping thread thereby tapping or cutting a mating thread or an undercut into the wall of the drilled hole in the component.

Components or workpieces made of a mineral material, such as concrete or masonry, in which a fastening element of the species is generally set, contain brittle materials. The geometry of the drilled hole is largely dependent on the quality, as well as the geometry of the drill. In practice, the form of the prepared drilled holes deviates from an optimal cylindrical shape, the diameter of the drilled holes typically narrowing toward the bottom ends thereof.

To ensure the settability of a fastening element of the species in the drilled holes, a drill having a larger nominal diameter than the thread-core diameter of the shank of the fastening element is used to prepare the drilled holes. In this context, the nominal drill diameter must not be selected to be too large relative to the thread-core diameter of the shank of the fastening element since, otherwise, there will be a significant decline in the transmittable limit loads. The thread-core diameter is understood to be the outside diameter of the shank in the region of the thread.

U.S. Pat. No. 5,800,107 discusses a fastening element having a polygonal head as a torque-receiving means for a wrench socket or a spanner wrench as a setting tool and having a shank bearing a tapping thread that has a free end facing away from the torque-receiving means and that has a thread-core diameter. The thread has at least one thread having a thread leading end in the region of the free end of the shank, whose outside diameter, starting from the free end, increases to a maximum outside diameter. Starting from the maximum outside diameter, the outside diameter of the at least one thread decreases continuously toward the torque-receiving means. At the free end, the shank has an insertion portion, whose outside diameter, starting from the free end, increases up to a maximum core diameter of the shank. The thread-core diameter of the shank likewise decreases continuously starting from the maximum thread-core diameter and continuing toward the torque-receiving means.

The drawback of the known approach is that the outside diameter of the at least one thread and the thread-core diameter of the shank each decrease continuously in the same direction, whereby the known fastening element is not adapted to typically existing drilled hole geometries, so that, depending on the drilled hole geometry, a simple settability of the fastening element is not always given.

U.S. Pat. No. 5,282,708 describes a fastening element having a screw head as a torque-receiving means for a screwdriver as a setting tool and having a shank bearing a tapping thread that has a free end facing away from the torque-receiving means and, except for an insertion portion at the free end of the shank, having a constant thread-core diameter. The thread has at least one thread having a thread leading end in the region of the free end of the shank, whose outside diameter, starting from the free end, increases to a maximum outside diameter and, starting from the maximum outside diameter and continuing toward the torque-receiving means, decreases continuously to a smaller outside diameter.

The drawback of the known approach is that the shank is not adapted to the existing geometries of the drilled hole, and, therefore, depending on the geometry of the drilled hole, a simple settability of the fastening element is not given.

### SUMMARY OF THE INVENTION

An object of the present invention is, therefore, to devise a fastening element, in particular, for structural components made of mineral materials, which, in the set state, will have high limit loads and exhibit a substantial ruggedness in terms of its setting properties.

In accordance with the present invention, the thread-core diameter of the shank, starting from a region next to the torque-receiving means and continuing toward the free end of the shank, decreases quasi-continuously to a smaller thread-core diameter of the shank.

The thread-core diameter of the shank increases toward the torque-receiving means, the outside diameter of the thread decreasing toward the torque-receiving means. Thus, an effective settability of the fastening element in the drilled holes is given. The greatest proportion of the load is introduced into the structural component through the larger undercut at a distance from the mouth of the drilled hole. This ensures a comparatively higher load-carrying capacity than that of fastening elements of the species known till now. Since the shank near the mouth of the drilled hole has a large thread-core diameter, which is advantageously only slightly smaller that the inside diameter of the drilled hole in this region and thus has a correspondingly large material cross section, high transverse forces, vertical forces, flexural torques and thread-stripping torques are transmittable in the set state of the fastening element.

In this context, thread-stripping torque is understood to be the torque that leads to a failure of the screw under torsional stress. Due to safety considerations, the thread-stripping torque should be significantly greater than the torque required for setting the fastening element.

In this connection, decreasing quasi-continuously is understood to mean a substantially continuous or constant decrease in the thread-core diameter of the shank, respectively in the outside diameter of the thread. The decrease in the diameter in question may also be effected in advantageously uniform, small steps, so that the decrease over the entire extent of the shank, respectively of the thread, may be regarded, in turn, as being substantially continuous.

The thread-core diameter of the shank decreases linearly, thereby ensuring that the fastening element has advantageous characteristics in terms of the ease with which it may be screwed into the component.

The shank preferably has a longitudinal extent, and the shank portion having the continuously diminishing thread-core diameter extends over more than 50% of the longitudinal extent of the shank, whereby the fastening element is advantageously designed for setting of the same into the drilled holes that are typically present in practice.

The shank portion having the continuously decreasing thread-core diameter preferably extends, starting from the region next to the torque-receiving means, to a region of the shank where the at least one thread has its maximum outside diameter. Thus the shank narrows continuously directly from the torque-receiving means, respectively at a distance therefrom, to the insertion portion of the shank, which, for its part, is tapered toward the free end. If the shank does not have an insertion portion, then the shank portion having the continuously decreasing thread-core diameter advantageously extends to the free end of the shank.

In the region of the torque-receiving means, the thread-core diameter of the shank preferably corresponds to 1.01 to 1.5 times, advantageously to 1.05 to 1.2 times the smaller thread-core diameter, thereby ensuring that the fastening element has advantageous characteristics in terms of the ease with which it may be screwed into the component.

The outside diameter of the at least one thread preferably decreases linearly, thereby ensuring that the fastening element has advantageous characteristics in terms of the ease with which it may be screwed into the component.

The maximum outside diameter of the at least one thread preferably corresponds to 1.01 to 1.5 times, advantageously to 1.05 to 1.2 times the smaller outside diameter of the at least one thread, thereby ensuring that the fastening element has advantageous characteristics in terms of the ease with which it may be screwed into the component.

The thread is preferably provided with at least one additional, separate thread which has a constant outside diameter. The at least one additional, separate thread is advantageously provided in-between the thread having the continuously diminishing outside diameter and, also advantageously, has the same pitch as the same. Due to its constant outside diameter, the at least one additional, separate thread provides guidance for the fastening element during the setting process. An especially advantageous guidance of the fastening element is ensured when the constant outside diameter substantially corresponds to the nominal diameter of the drilled hole into which the fastening element is set.

### BRIEF DESCRIPTION OF THE DRAWINGS

The present invention is explained in greater detail below with reference to an exemplary embodiment. The only FIGURE shows a fastening component according to the present invention in a lateral view.

### DETAILED DESCRIPTION

Fastening element 11 illustrated in the FIGURE has a hexagonal head as a torque-receiving means 12 for a setting tool and a shank 16 bearing a tapping thread 21. Shank 16 extends along a longitudinal axis 17 and has a free end 18 facing away from torque-receiving means 12, and has a thread-core diameter. Torque-receiving means 12 can be any type of torque-receiver, such as a screw or bolt head.

The thread-core diameter of shank 16, starting from a region 19 next to torque-receiving means 12 and continuing toward free end 18 of shank 16, decreases continuously and linearly to a smaller thread-core diameter K2 of shank 16. The shank portion having the continuously diminishing thread-core diameter extends over more than 50% of the longitudinal extent of shank 16. In this example, the shank portion having the continuously diminishing thread-core diameter extends to an insertion portion 27 at free end 18 of shank 16. Insertion portion 27 is tapered toward free end 16 and renders possible a simple introduction of fastening element 11 into a drilled hole (not shown here). In region 19 of torque-receiving means 12, thread-core diameter K1 of shank 16 corresponds to 1.01 to 1.5 times, advantageously to 1.05 to 1.2 times the smaller thread-core diameter K2 in region 26 of free end 18 of shank 16.

Thread 21 has a thread 22 having a thread leading end 23 in region 26 of free end 18 of shank 16, as well as an additional, separate thread 32 configured in-between thread 22. The outside diameter of thread 22 at thread leading end 23 increases, starting from free end 18, to a maximum outside diameter A2 of thread 22. Starting from its maximum outside diameter A2 and continuing toward torque-receiving means 12, the outside diameter of thread 22 decreases continuously and linearly to a smaller outside diameter A1. Maximum outside diameter A2 of thread 22 corresponds to 1.01 to 1.5 times, advantageously to 1.05 to 1.2 times the smaller outside diameter A1 of thread 22. With the exception of its thread leading end and its thread trailing end, outside diameter A3 of additional, separate thread 32 is substantially constant over the entire extent, whereby a guidance of fastening element 11 is given during the process of setting of the same into a drilled hole.

1-8. (canceled)

9: A fastening element comprising:
a torque receiver for a setting tool; and
a shank having a tapping thread and a free end facing away from the torque receiver, and having a thread-core diameter,
the tapping thread having at least one thread having a thread leading end in a region of the free end of the shank, whose outside diameter, starting from the free end, increases to a maximum outside diameter and, starting from its maximum outside diameter and continuing toward the torque receiver, decreases quasi-continuously to a smaller outside diameter,
wherein the thread-core diameter of the shank, starting from a region next to the torque-receiver and continuing toward the free end of the shank, decreases quasi-continuously to a smaller thread-core diameter of the shank.

10: The fastening element as recited in claim 9 wherein the thread-core diameter of the shank decreases linearly.

11: The fastening element as recited in claim 9 wherein the shank has a longitudinal extent, and the shank portion having the continuously diminishing thread-core diameter extends over more than 50% of the longitudinal extent of the shank.

12: The fastening element as recited in claim 11 wherein the shank portion having the continuously decreasing thread-core diameter extends, starting from the region next to the torque-receiver, to a region of the shank where the at least one thread has its maximum outside diameter.

13: The fastening element as recited in claim 9 wherein, in the region of the torque-receiver, the thread-core diameter of the shank corresponds to 1.01 to 1.5 times the smaller thread-core diameter.

14: The fastening element as recited in claim 13 wherein the thread-core diameter of the shank corresponds to 1.05 to 1.2 times the smaller thread core diameter.

15: The fastening element as recited in claim 9 wherein the outside diameter of the at least one thread decreases linearly.

16: The fastening element as recited in claim 9 wherein the maximum outside diameter of the at least one thread corresponds to 1.01 to 1.5 times the smaller outside diameter of the at least one thread.

17: The fastening element as recited in claim 16 wherein the maximum outside diameter of the at least one thread corresponds to 1.05 to 1.2 times the smaller outside diameter of the at least one thread.

18: The fastening element as recited in claim 9 wherein the tapping thread has at least one additional, separate thread having a constant outside diameter.
